(19) United States
(12) Patent Application Publication
(10) Pub. No.: US 2007/0180100 A1
(43) Pub. Date: Aug. 2, 2007

(54) Realtime Approval Control

(75) Inventors: Todd S Biggs, Kirkland, WA (US); Matthew C. Carlson, Seattle, WA (US); Mark T.K. Looi, Issaquah, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,840

(22) Filed: Jan. 31, 2006

(51) Int. Cl. G06F 15/173

(52) U.S. Cl. 709/224

(57) ABSTRACT

Real time approval control systems and methods are provided. In at least some embodiments, a presence-based network is utilized to provide a parent or other adult who is in a position to approve or deny a request, more timely access to information to facilitate the decision-making process.

### BACKGROUND

Today, administration of parental controls for example, receiving and acting upon a request from a child to visit a web site or add a new contact to their email or instant messaging or VoIP client, is largely conducted via email. That is, when a child wishes to visit a particular web site or add a contact, the designated parent is typically notified by email. This can create a significant lag time between a request from a child and their parent reviewing and approving or denying the request. For example, the parent may be online when the request is sent by their child, but unless the parent is signed in and reading his or her email and specifically sees the request from their child, the request could wait a long time until it is acted upon.

### SUMMARY

Real time approval control systems and methods are provided. In at least some embodiments, a presence-based network is utilized to provide a parent or other adult who is in a position to approve or deny a request, more timely access to information to facilitate their decision-making process.

### BRIEF DESCRIPTION OF THE DRAWINGS

FIG. 1 is a high level diagram of a system in which the inventive embodiments can be employed.

FIG. 2 is a flow diagram that describes steps in a method in accordance with one embodiment.

FIG. 3 is a high level diagram of a system in accordance with one embodiment.

FIG. 4 is a diagram of aspects of a system in accordance with one embodiment.

FIG. 5 illustrates one exemplary notification in accordance with one embodiment.

FIG. 6 illustrates one exemplary notification in accordance with one embodiment.

FIG. 7 illustrates an exemplary system in accordance with one embodiment.

FIG. 8 illustrates one exemplary notification in accordance with one embodiment.

FIG. 9 illustrates a conversation window in accordance with one embodiment.

### DETAILED DESCRIPTION

Overview

In the embodiments described below, real time approval control systems and methods are provided. In his document, the term “parental control” is utilized to describe the real time approval control embodiments. This term is not, however, intended to require a parent to participate. Rather, the term “parental control” simply describes a system in which one person—typically an adult or guardian, has approval authority over another—typically, but not always a child.

In this document, parental control can manifest itself in different ways. For example, one type of parental control manifests itself in the form of an access control. An access control is designed to control access to a particular resource, such as a web site, service or some other web-accessible entity. Another type of parental control manifests itself in the form of an in-line control. An in-line control is designed to control or otherwise monitor in-line content. For example, once a user has been approved for a particular site—perhaps a chat room—the in-line control can monitor conversations and can permit a person with approval authority to approve or disapprove the content of conversations that take place.

In the discussion that follows, various real time approval control embodiments are described.

A first embodiment, appearing under the heading “One-Way Notification/Approval” describes an approach in which communication of a triggering event to a person of authority is generally one way. That is, the occurrence of a triggering event or request is communicated to a person of authority and then measures are taken to provide this person with a means to approve or disapprove the event or request. A triggering event can reside in the form of an attempt to access a web resource, add a contact to a particular application (such as email, instant messaging, VoIP and the like), take part in an online conversation, to name just a few examples.

A second embodiment, appearing under the heading “Two-Way Notification/Approval” describes an approach in which an approval conversation is started with the person of authority and approval/denial of an event or request takes place in a conversational manner.

In the embodiments described below, real time approval control can be implemented in connection with a presence-based network and applications that execute within that environment. One type of application is an instant messaging application. However, before describing the inventive embodiments in detail, the following discussion of the notion of presence is provided to give the reader who is unfamiliar with presence and presence-based networks a basic understanding of the same.

Presence In General

The notion of presence typically implies the use of a server or service that runs and keeps online users updated with each other's contacts' online status. That is, in a presence based network, users can identify so-called contacts—the same or similar to those that appear in the user's email address list. Whenever a contact is online, the presence based network notifies the user so that the user can leverage the services provided by the network—such as instant messaging, peer-to-peer file exchange and the like. That is, the presence based network can enable contacts that are online together to communicate in a real-time fashion.

One commercially-available software product that provides presence capabilities is MSN Messenger, although other products are available. MSN Messenger is a rich, integrated real-time communications experience in Windows® XP that enables people to effortlessly see, talk, work and play with friends, family and colleagues, whenever and however they choose using their personal computer. MSN Messenger also includes presence and notification features to keep users updated when their contacts are online and let users know their current status.

Various embodiments described below can leverage the functionality provided by a presence-based network. It is to be appreciated and understood that MSN Messenger constitutes but one exemplary application that can be utilized in this context. As such, other applications can be utilized without departing from the spirit and scope of the claimed subject matter.

Exemplary Presence-Based Network

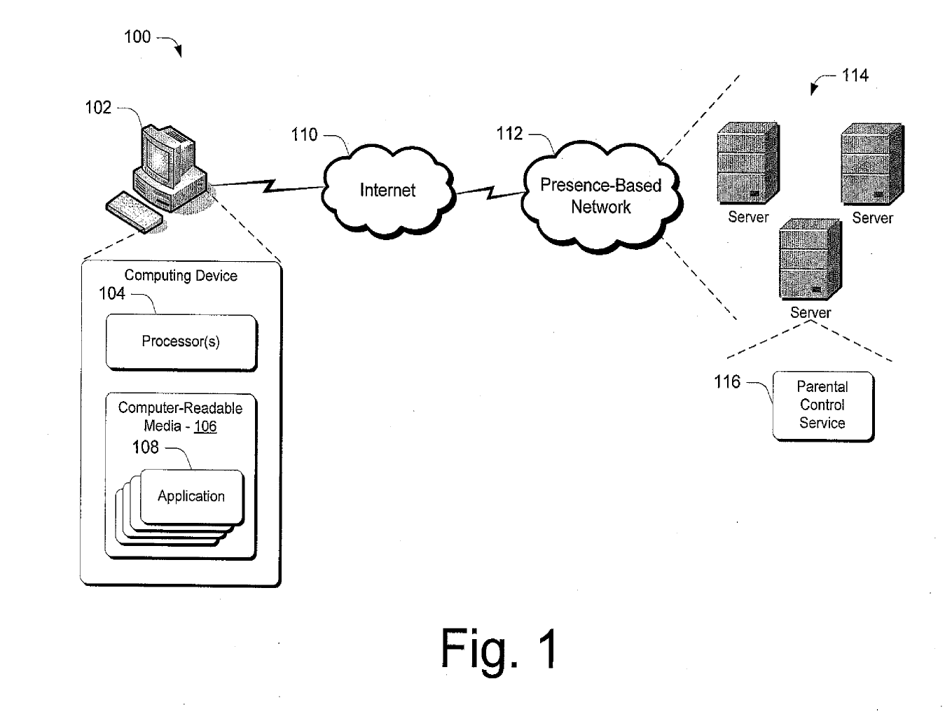

As an example of a presence-based network in accordance with one embodiment, consider FIG. 1 which illustrates such a network or system generally at 100. System 100 includes one or more computing devices 102 each of which includes one or more processors 104, one or more computer-readable media 106 and one or more applications 108 that reside on the computer-readable media and which are executable by the processor(s). In at least one embodiment, one of the applications resides in the form of an instant messaging application, such as Microsoft's MSN Messenger.

Although computing device 102 is illustrated in the form of a desktop computer, it is to be appreciated and understood that other computing devices can be utilized without departing from the spirit and scope of the claimed subject matter. For example, other computing devices can include, by way of example and not limitation, portable computers, handheld computers such as personal digital assistants (PDAs), cell phones and the like.

System 100 also includes a network, such as the Internet 110 that is used by computing device 102 to communicate with a presence-based network 112. Any suitable protocols can be utilized to enable communication between computing device 102 and presence based network 112.

As shown, presence-based network 112 includes one or more servers 114 that implement the presence environment, as will be appreciated by the skilled artisan. The presence-based network can be one that includes or supports the use of instant messaging, VoIP, voice clips and the like—all of which can permit a user of computing device 102 to communicate with the network. Instant messaging, VoIP and voice clip protocols will be understood by the skilled artisan and, for the sake of brevity, are not further described here.

In at least some embodiments, server 114 includes or otherwise has access to a parental control service 116 that can implement the functionality described below. The parental control service 116 can reside in a number of different types of form. For example, the service can reside in the form of a component or components that reside on the server. Alternately or additionally, the service can reside in the form of a web page that marshals a person of authority through the approval process, as will be described below.

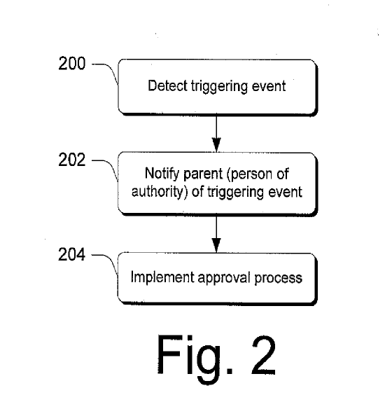

FIG. 2 is a flow diagram that described steps in a notification/approval method in accordance with one embodiment. The steps can be implemented in connection with any suitable hardware, software, firmware or combination thereof. In at least one embodiment, the method can be implemented in software, at least in part, in the form of an application that resides on a server, such as server 114 (FIG. 1) that operates in a presence-based environment, and/or at least in part by an application that resides on a client computing device, such as computing device 102.

Step 200 detects a triggering event associated with a person whose on-line actions are being monitored by a person with approval authority. This step can be implemented by one or more components of the presence-based network, such as by software executing on a server. In this example, a triggering event can comprise any suitable event. For example, once a parent registers or otherwise signs up their child with the presence-case network, the triggering event can comprise things such as a child attempting to add a particular contact to their list of contacts, the child attempting to access a particular web site, someone attempting to engage the child in a chat session and the like. Once the triggering event has been detected, step 202 notifies the parent (or person of authority) of the triggering event. The notification can take any suitable form. For example, the notification can be generated and sent to the parent over the presence-based network. Hence, if the parent is online, the notification can be sent via their instant messaging application to notify them, in real time, of the triggering event. Alternately or additionally, if the parent or person of authority's presence is not detected on the network, attempts can be made to notify them in different ways. For example attempts can cycle through alternate notification means until a response is received or a timeout occurs. These other notifications can include, by way of example and not limitation, a browser toolbar notification, telephonic notification (such as a desk phone or mobile phone), email notification and the like.

Having notified the parent via the presence-based network, step 204 implements an approval process. In at least some embodiments, the approval process can enable the parent or person of authority to approve or deny a request associated with the triggering event. Alternately or additionally, the approval process can be implemented through a delegate of the parent or person of authority. This delegate may or may not be a human. In the non-human case, the delegate could use programmed heuristics or rules to provide or deny their approval. The approval process can be implemented as part of the notification step, as described in detail below. Alternately or additionally, the approval process can be implemented separately from the notification step, as will be described in detail below.

One-Way Notification/Approval

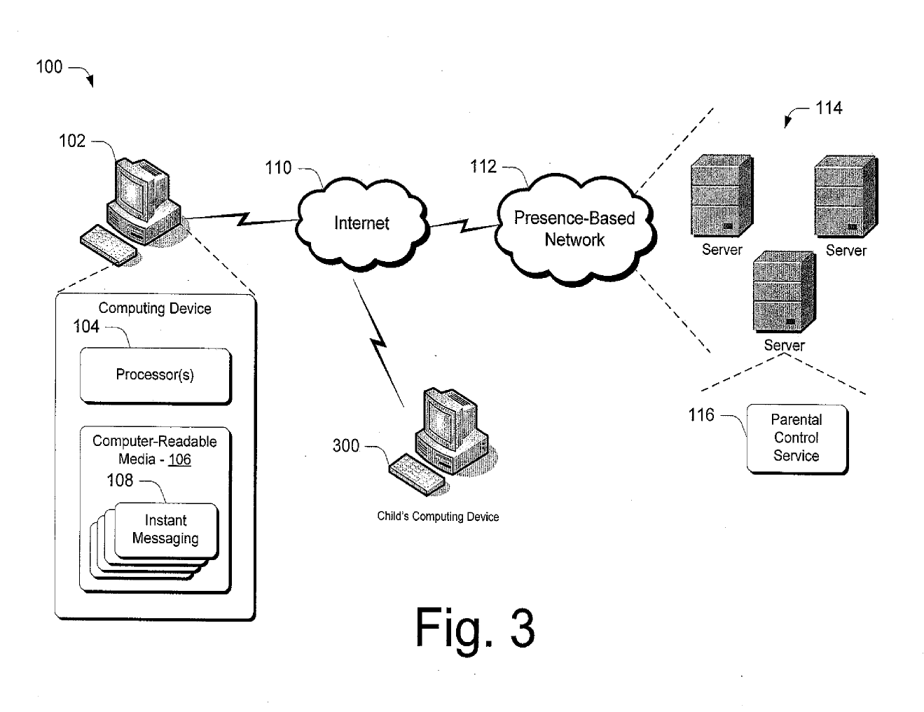

FIG. 3 illustrates an exemplary system that can implement the above described functionality in accordance with one embodiment. Here, the system of FIG. 3 includes components that are the same as or similar to those described in connection with FIG. 1. Accordingly, for the sake of brevity, such description is not repeated here. Notice, however, that computing device 102 is executing an instant messaging application 108. It is through the instant messaging application, in this embodiment, that notifications are presented to a parent or person having approval authority.

Assume in this example, that computing device 102 belongs to a parent or person having approval authority. Notice also that a child's computing device 300 is shown. Assume in this example, that a child, in connection with the presence-based network, takes an action that generates a triggering event. In this case, a one-way communication can be generated to computing device 102 or application 108 to provide the parent or person of authority with an opportunity to approve or disapprove a request associated with the triggering event.

In the illustrated and described embodiments, this can happen in a couple of different ways, each of which is described just below.

Redirection to a Parental Control Site/Service

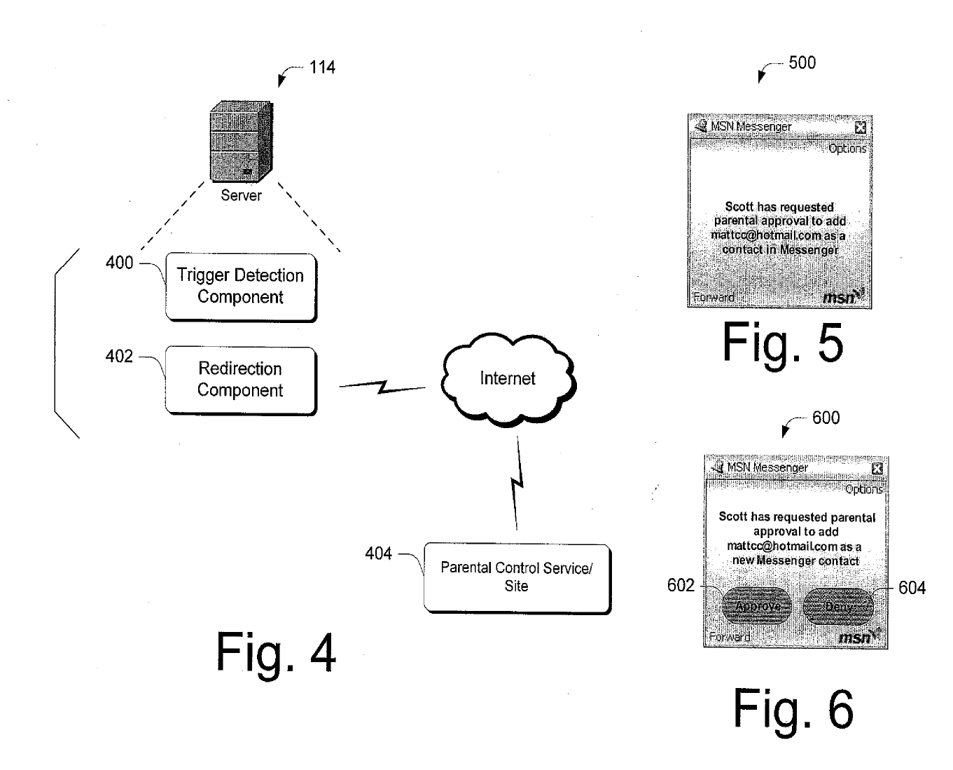

In one embodiment, when a triggering event is detected, the approval process redirects the parent to a parental control site or service. In one embodiment, this site or service can reside in the form of a web page. As an example, consider FIG. 4 and the following discussion.

There, a web server 114 in the presence-based network includes or otherwise has access to a trigger detection component 400 and a redirection component 402.

The trigger detection component is configured to detect events that it has been programmed to detect, such as when a particular child attempts to access a web site or include a new person in his or her contact list. One example of a trigger detection component is an alert service, an example of which is provided below.

The redirection component is configured to, in addition to notifying the parent or person of authority via the presence-based network, redirect such person's software to a parental control service or site 404. Such redirection can take place via the Internet, as illustrated. Alternately or additionally, the redirection can take place to another component within server 114. Once at the parental control service or site, the parent can be given the opportunity to approve or disapprove a particular request associated with the triggering mechanism.

As an example, consider the following. As part of establishing part of his or her presence in the presence-based network (or independently from the presence-based network), a parent can register with an alert service to be notified when certain events occur. Any suitable alert service can be used. But one example of a suitable alert service is MSN® Alerts, which is a real-time communication service which delivers notifications about information about which users are concerned. This particular service operates on the .Net Messenger service and uses a user's presence to control the routing of notifications, as will be appreciated by the skilled artisan. These notifications can also be routed to end-points that are not on the presence-based network, such as email and mobile end-points.

Assume now that a parent has opted in to receiving requests for parental control via an alert/notification service when a child of the parent makes a request that triggers parental control (such as adding a new contact to his or her instant messaging contact list), the alert service, aspects of which can be embodied in trigger detection component 400, acts in concert with redirection component 402 to push the request to the designated approving adult.

Assume now that the parent or approving adult is at his or her computer at home or work. Responsive to detecting the triggering event the parent or approving adult receives a notification that informs them of the request or event.

An example of such a notification is shown in FIG. 5 generally at 500. In this example, the notification is presented to the approving adult via the presence-based network in the form of a notification that is received and rendered for the parent by their instant messaging application. The parent can then review the request and, by clicking on the request can be redirected to the parental control service or site 404. Once at the service or site, the parent can be further prompted to approve or disapprove the request. Once a request is approved or disapproved, such can be conveyed back to a server or the child's computing device to either allow or disallow an associated action.

In this embodiment, the notification that the approving adult receives contains redirection means that redirect him or her to an alternate location at which the approval process can be implemented. This can reside in the form of an embedded link to the site or service.

Concurrent Alert with Approval Instrumentality

In another embodiment, the notification that the approving adult receives includes, in the notification itself, the means or instrumentalities by which approval can be given or denied.

As an example, consider FIG. 6 which shows a notification, generally at 600, in accordance with one embodiment. In this example, assume all of the facts of the above example When the approving adult receives, a notification, however, instrumentalities in the form of an approve button 602 and a deny button 604 are provided. Here, by simply clicking on the appropriate button, approval or denial of the request can be returned to the server for appropriate action. In this example, the approving adult is not redirected to another site or service.

Two-Way Notification/Approval

In the embodiment described just below, the communication that takes place to permit approval or denial of a request associated with a triggering event takes place via a two way communication path. More specifically, in this embodiment, an approval conversation is started with the person of authority and approval/denial of an event or request takes place in a conversational manner. In the specific example described below, the conversation takes place via a conversation window that is rendered by an instant messaging application.

In the specifically illustrated embodiment, a bot (short for “robot”) is utilized to communicate with the approving adult, as well as manage the approval process within the instant messaging environment. The bot, which resides as a contact in the parent's contact list, generates the request for approval and engages the adult in an interaction or conversation via the instant messaging client executing on the adult's computing device.

Before further describing this embodiment's functionality, a description of an exemplary system that can implement the functionality is provided just below. It is to be appreciated and understood that other systems can be used to implement the functionality described below without departing from the spirit and scope of the claimed subject matter.

Exemplary Application/Bot Implementation

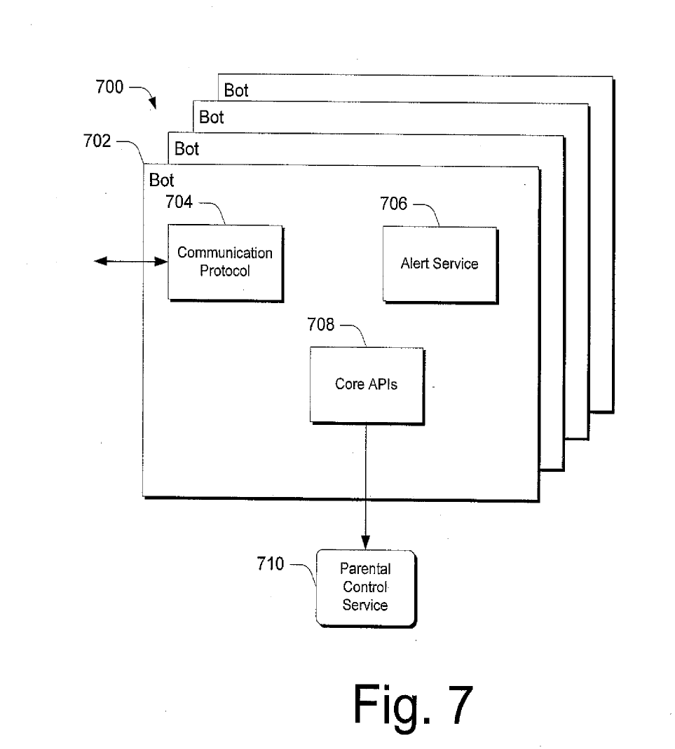

FIG. 7 illustrates a collection of bots generally at 700, an example of which is specifically shown at 702 in accordance with one embodiment. In practice, individual servers in the presence based network can host a number of different bots and/or different types of bots. In this particular instance, the hosted bot is a parental control bot. The bots are typically implemented in software in the form of computer-readable instructions that reside on some type of computer-readable media. In this example, users interact with bots just like they would other users on the presence-based network. The bot can use simple text exchanges with human users or, alternatively, audio and/or video in addition to or in place of text, such as through Voice IP (VoIP), voice clips and the like.

In this example, bot 702 includes components that can implement the functionality described above and below. It is to be appreciated and understood that the specifically-illustrated bot constitutes but one exemplary bot that can implement the described functionality. Accordingly, other bots can be utilized without departing from the spirit and scope of the claimed subject matter.

In this particular example, bot 702 includes, by way of example and not limitation, a communication protocol component 704, an alert service 706 and a core API component 708.

Communication protocol component 704 is configured to communicate with the presence network and client application executing on remote a computing device, such as a child's and parent's computing device. Component 704 handles all conversational aspects and capabilities. Any suitable communication protocol can be utilized. In the instant messaging embodiments, the protocol includes peer-to-peer capabilities.

Alert service 706 can comprise any suitable service with which a user can register for notifications. An example of one such service is given above. Additionally, while the alert service is shown to reside as part of the bot 702, it is to be appreciated and understood that the alert service could be a third party service or could otherwise reside outside of the bot.

Core APIs 708 comprise a collection of APIs that are utilized to access or leverage outside services. That is, the core APIs 708 are configured to leverage available services by making and receiving programmatic calls to and from components that make up such services. In this particular example, the core APIs are used to leverage the services of a parent control service 710. The parental control service is configured to interact with a parent or person of authority to allow the parent to provide or deny his or her approval of a request associated with a triggered event. It is to be appreciated and understood that the parent control service could reside as part of bot 702.

In Operation

In operation, when a child user interacts with an application, communication protocol 704 communicates with the alert service 706 to allow the alert service to ascertain whether a triggering event has occurred. If a triggering event has occurred, alert service 706 uses core APIs 708 to engage parental control service 710. Parental control service 710 then interacts with the parent, either directly or back through the core APIs, to notify the parent and allow the parent to provide or deny his or her approval of a request associated with a triggered event.

As but one example of how this can be implemented, consider the following.

In this example, assume that a parent has opted in to receiving requests for parental control via an instant messaging-enabled notification service by adding a bot that manages parental controls to their messenger contact list. Now assume that a child of the parent makes a request for parental approval by, for example, attempting to add a new contact to the child's messenger contact list. In this example, the system which manages the requests from children for parental control interacts with the server on which the bot is running to push the request to the designated approving adult. In the FIG. 7 example, the request comes in through the communication protocol component 704 which uses alert service 706 which, in turn utilizes core APIs 708 as described above. The application on which the bot is running need not necessarily comprise a part of the messenger network, but could comprise an application server connected to the network and could be operated by a company or some other third party.

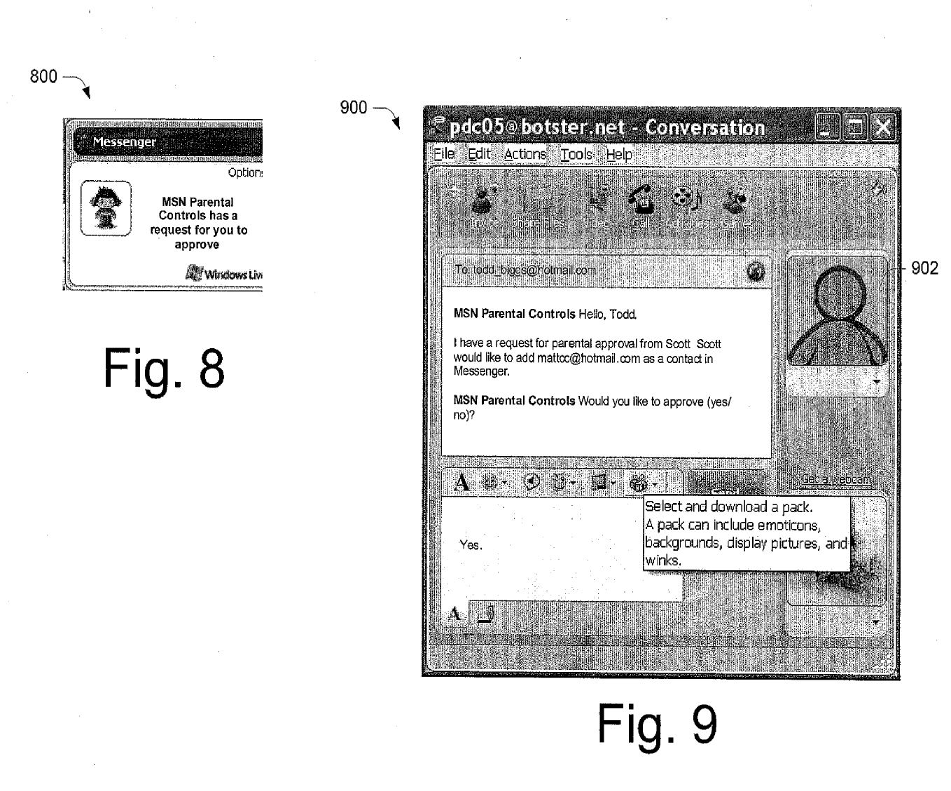

Assume now that the parent is at their computer at home or work and is signed into their instant messaging application. In this case, the parent would then receive, through the presence-based network, a notification that informs them of the request. As but one example of an exemplary notification, consider FIG. 8 which illustrates an exemplary notification generally at 800. Here, the notification is a prompt to engage in an instant messaging conversation with the bot that manages the parental controls for the application that the child is engaging.

At this point, the parent can start an instant messaging conversation with the parental control bot by opening a conversation window. The conversation describes the request waiting for their approval and what to type (or state in the case of VOIP) to approve the request. As but one example of a conversation window, consider FIG. 9. There, an exemplary conversation window 900 is shown and includes an icon 902 that represents the hot with which the parent or user is to converse. Notice also in this example, that the bot has greeted the user and indicated that there is a request for parental approval from “Scott”. The hot then prompts the parent as to whether they wish to approve the request.

Accordingly, the parent can review the request and approve or deny the request within the instant messaging experience via the illustrated text communication window, as requested by the hot. In this example, the parent has approved the request by typing “yes” in their response box.

It is to be appreciated and understood that while this example utilizes a text communication channel, the bot can use a voice communication channel within an instant messaging client or a VoIP client and prompt an adult for a verbal “yes” or “no” for the request.

Conclusion

The described embodiments can mitigate problems associated with delays in seeking and receiving parental approval. By leveraging a presence-based network, at least some embodiments can reduce the time between when a parental approval request is generated and when it is received and acted upon by the parent.

Although the invention has been described in language specific to structural features and/or methodological steps, it is to be understood that the invention defmed in the appended claims is not necessarily limited to the specific features or steps described. Rather, the specific features and steps are disclosed as preferred forms of implementing the claimed invention.

1. A computer-implemented method comprising:
detecting a triggering event associated with a person whose on-line actions are being monitored by a person with approval authority; and
attempting to notify, via a presence-based network, said person with approval authority of the triggering event.

2. The method of claim 1, wherein the act of attempting to notify is performed by attempting to notify said person with approval authority via an instant messaging application.

3. The method of claim 1 further comprising implementing an approval process in which approval of a request associated with the triggering event can be given or denied.

4. The method of claim 3, wherein the act of implementing the approval process redirects to a parental control service.

5. The method of claim 3, wherein the act of implementing the approval process redirects to a parental control service, wherein the parent control service comprises a web page that is presented to said person with approval authority.

6. The method of claim 3, wherein the act of implementing the approval process comprises including, in a notification that is provided to said person with approval authority, instrumentalities by which approval can be given or denied.

7. The method of claim 1, wherein said act of attempting to notify comprises, in an event a notification cannot be sent via the presence-based network, attempting to notify using another means of notification.

8. One or more computer-readable media having computer-readable instructions thereon which, when executed, implement the method of claim 1.

9. A computer-implemented method comprising:
detecting a triggering event associated with a person whose on-line actions are being monitored by a person with approval authority;
notifying, via a presence-based network, said person with approval authority of the triggering event, wherein said notifying comprises enabling said person with approval authority to start an approval conversation.

10. The method of claim 9, wherein the act of enabling an approval conversation comprises using a conversation window that is rendered by an instant messaging application.

11. The method of claim 9, wherein the act of enabling an approval conversation comprises using a conversation window that is rendered by an instant messaging application, and wherein said approval conversation is initiated by a bot that is a contact in a contact list of said instant messaging application.

12. The method of claim 9, wherein said approval conversation comprises a text exchange.

13. The method of claim 9, wherein said approval conversation does not comprise a text exchange.

14. One or more computer-readable media having computer-readable instructions thereon which, when executed, implement the method of claim 9.

15. One or more computer-readable media having computer-readable instructions thereon which, when executed, implement a method comprising:
responsive to a triggering event associated with a person whose on-line actions are being monitored by a person with approval authority being detected, receiving, from a parental control robot (bot), a notification that prompts said person with approval authority to engage in an instant messaging conversation;
starting an instant messaging conversation with the parental control bot by opening a conversation window; and
receiving, via the conversation window, a description of a request associated with the triggering event and a description of how to respond to approve or deny the request.

16. The one or more computer-readable media of claim 15, wherein the parental control robot is a contact in a contact list associated with an instant messaging application that provides said conversation window.

17. The one or more computer-readable media of claim 15, wherein said instant messaging conversation is a textual conversation.

18. The one or more computer-readable media of claim 15, wherein said instant messaging conversation is not a textual conversation.

19. The one or more computer-readable media of claim 15 further comprising presenting, as part of the conversation window, a text communication window in which said person with approval authority can type in an approval or denial.

20. A computing device embodying the one or more computer-readable media of claim 15.
